(19) United States
(12) Patent Application Publication
(10) Pub. No.: US 2004/0169971 A1
(43) Pub. Date: Sep. 2, 2004

(54) Combined audio and power connector

(76) Inventors: James J. Hinsberger, Oak Park, CA (US); J. Roger Davis, Russiaville, IN (US)

Correspondence Address: DELPHI TECHNOLOGIES, INC., M/C 480-410-202, PO BOX 5052, TROY, MI, 48007, US

(21) Appl. No.: 10/375,901

(22) Filed: Feb. 27, 2003

(51) Int. Cl. H02H 7/00

(52) U.S. Cl. 361/62

(57) ABSTRACT

A combined audio and power connector facilitates the use of portable audio devices with audio systems, including but not limited to vehicle audio systems. By integrating an audio input and a power supply into a single connector, the need to use multiple cords, e.g., one for the power supply and another for the audio input, is avoided. Further, a vehicle can deliver power to many types of portable devices without the use of relatively large auxiliary power jacks. As a result, many or most of the auxiliary power jacks currently incorporated in vehicle designs can be eliminated, making additional space available for other applications.

### TECHNICAL BACKGROUND

The present invention relates generally to audio systems. More particularly, the present invention relates to connection techniques for use in connection with audio systems.

### BACKGROUND OF THE INVENTION

Vehicle audio systems provide information and entertainment to many motorists daily. These audio systems typically include an AM/FM radio receiver. In addition, many vehicle audio systems include devices for listening to previously recorded media, such as cassettes and compact discs (CDs). Some vehicle audio systems also have video capabilities, e.g., a digital versatile disc (DVD) player.

An audio system for use in a vehicle or in another operating environment may provide an audio input jack into which a stereo or monaural plug can be inserted. Inserting such a plug into the audio input jack enables the audio system to receive a stereo or monaural audio signal from external devices. Examples of external devices that can be arranged to provide an audio signal to the audio system in this way include, but are not limited to, portable audio devices such as compact disc (CD) players, digital versatile disc (DVD) players, MiniDisc (MD) recorders, and MP3 players and other devices that read and decode compressed audio formats. In addition, other types of devices can be arranged to provide an audio signal to the audio system in this way, such as laptop computers, wireless telephones, video game players, and other devices that have audio output jacks.

Portable audio devices typically operate on direct current (DC) power that can be obtained from at least two types of sources. Batteries, for example, allow a portable audio device to be operated without an external power source. Accordingly, batteries are ideal for operating scenarios in which the portable audio device lacks access to an external power source, e.g., a portable CD player or radio used by a jogger. Batteries, however, can only deliver a limited amount of power before they are depleted and must be either recharged or discarded and replaced.

In some operating environments, an external power source is available to the portable audio device. For example, an alternating current (AC) adapter may convert house current to DC power for delivery to the portable audio device. As another example, motor vehicles typically incorporate one or more auxiliary power jacks that can deliver DC power to a portable audio device via an auxiliary power cord, also known as a cigarette lighter adapter.

The use of an auxiliary power jack to power a portable audio device operating in a motor vehicle eliminates the need for battery power and, as a result, the need to recharge or replace depleted batteries. Accordingly, this type of power source is suitable for situations in which a portable audio device is used for an extended duration, e.g., on long road trips. Conventional auxiliary power jacks, however, present some drawbacks that make their use less than optimal. Portable audio devices connected to such jacks require the use of an unwieldy arrangement of at least two cords: the auxiliary power cord and an audio cord. In addition, the auxiliary power jacks themselves occupy a considerable amount of space on the vehicle. But for the presence of auxiliary power jacks, this space could be used for other purposes.

### SUMMARY OF THE INVENTION

According to an example embodiment of the present invention, an electrical interface includes a cord having a plurality of conductors. One portion of the cord is divided into a two branches, each including a subset of the conductors. An audio connector is coupled to one branch and is arranged to conduct an audio signal. A power connector is coupled to the other branch and is arranged to conduct a power signal. Another connector is coupled to the cord and is arranged to conduct the audio signal and the power signal.

Another embodiment is directed to an electrical connector having at least one audio segment arranged to conduct an audio signal and a power segment. The power segment is housed with and electrically isolated from the at least one audio segment and is arranged to conduct a power signal. A common segment is housed with and electrically isolated from the at least one audio segment and the power segment and is arranged to provide a return path for the audio signal.

Still another embodiment is directed to an audio system having an electrical receptacle. The electrical receptacle includes a power segment coupled to a power supply. At least one audio segment is coupled to an audio input of the audio system and is arranged to conduct an audio signal from an external audio device to the audio system. The at least one audio segment is electrically isolated from the power segment. A common segment is electrically isolated from the at least one audio segment and the power segment and is arranged to provide a return path for the audio signal.

Various embodiments of the present invention may provide certain advantages. For example, by integrating an audio input and a power supply into a single connector, the need to use multiple cords, e.g., one for the power supply and another for the audio input, is avoided. In addition, a vehicle can deliver power to many types of portable devices without the use of relatively large auxiliary power jacks. As a result, many or most of the auxiliary power jacks currently incorporated in vehicle designs can be eliminated, making additional space available for other applications.

Additional objects, advantages, and features of the present invention will become apparent from the following description and the claims that follow, considered in conjunction with the accompanying drawings.

### BRIEF DESCRIPTION OF THE DRAWINGS

The present invention will now be described, by way of example, with reference to the accompanying drawings, in which:

FIG. 1 illustrates an example audio system that incorporates a combined power/audio input receptacle according to an embodiment of the invention.

FIG. 2 illustrates an example terminal for conducting a power signal and a stereo audio signal according to another embodiment of the invention.

FIG. 3 illustrates an example terminal for conducting a power signal and a monaural audio signal according to still another embodiment of the invention.

FIG. 4 is a schematic diagram illustrating an example circuit arrangement for conducting a power signal and an audio signal.

FIG. 5 is a schematic diagram illustrating another example circuit arrangement for conducting a power signal and an audio signal.

FIG. 6 is a schematic diagram illustrating yet another example circuit arrangement for conducting a power signal and an audio signal.

### DESCRIPTION OF PREFERRED EMBODIMENTS

Various embodiments of the present invention facilitate the use of portable audio devices with audio systems, including but not limited to vehicle audio systems. For example, by integrating an audio input and a power supply into a single connector, the need to use multiple cords—one for the power supply and another for the audio input—is avoided. Further, a vehicle can deliver power to many types of portable devices without the use of relatively large auxiliary power jacks. As a result, many or most of the auxiliary power jacks currently incorporated in vehicle designs can be eliminated, making additional space available for other applications.

The following description of various embodiments directed to a vehicle audio system is to be construed by way of illustration rather than limitation. This description is not intended to limit the invention or its applications or uses. For example, while various embodiments of the invention are described as being implemented in an audio system of a vehicle, it will be appreciated that the principles of the invention are applicable to audio systems in other types of operating environments, such as homes.

In the following description, numerous specific details are set forth in order to provide a thorough understanding of various embodiments of the present invention. It will be apparent to one skilled in the art that the present invention may be practiced without some or all of these specific details. In other instances, well known process steps have not been described in detail in order to avoid unnecessarily obscuring the present invention.

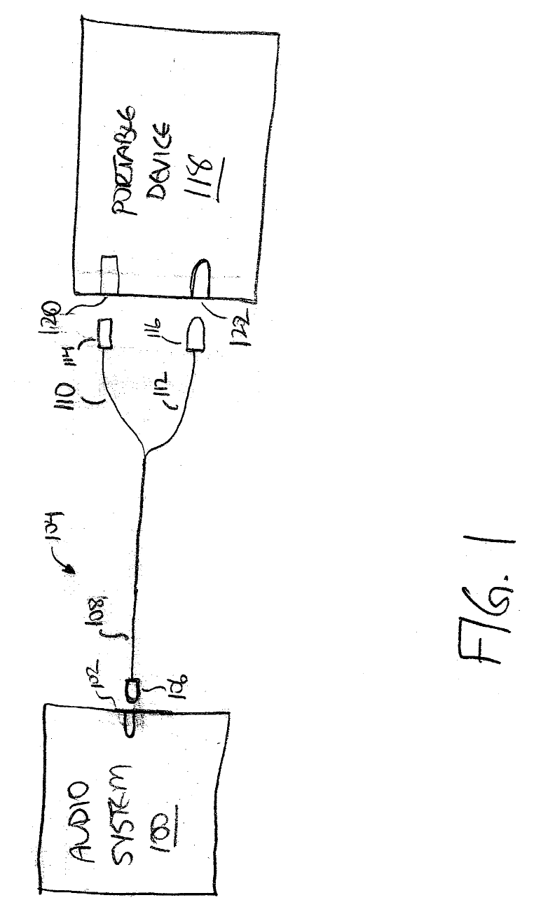

Referring now to the drawings, FIG. 1 illustrates an audio system 100 that incorporates a combined power/audio input receptacle 102 according to an example embodiment of the invention. While not required, the audio system 100 may be implemented as a vehicle audio system operating in an automobile or other vehicle. Alternatively, the audio system 100 may operate in an operating environment other than a vehicle, such as a home.

A power/audio cord 104 terminates at one end in a power/audio terminal 106 configured for insertion into the power/audio input receptacle 102. The power/audio terminal 106 is divided into segments, each of which is electrically coupled to a power supply, an audio channel, or an audio common line. Accordingly, the power/audio terminal 106 integrates both a power interface and an audio interface into a single terminal.

A body 108 of the power/audio cord 104 carries both power and audio signals. At the end opposite the power/audio terminal 106, the power/audio cord 104 is bifurcated into a power lead 110 and an audio lead 112. The power lead 110 includes a DC power conductor and a DC return conductor and terminates in a power terminal 114. The audio lead 112 includes one or more audio signal conductors and an audio common conductor and terminates in an audio terminal 116. In one implementation, the audio lead 112 carries a stereo audio signal and includes a left audio channel conductor, a right audio channel conductor, and an audio common conductor. In another implementation, the audio lead 112 carries a monaural audio signal and includes a single audio channel conductor and an audio common conductor.

A portable device 118 receives the power lead 110 in a power receptacle 120. The power receptacle 120 is arranged to deliver DC power to other circuitry within the portable device 118, thereby avoiding the need for battery power. Various characteristics of the power receptacle 120, such as the arrangement of conductors within the power receptacle 120 and the shape of the power receptacle 120, may vary between manufacturers. Accordingly, the power lead 110 may be implemented in any of a variety of configurations to conform with the characteristics of the power receptacle 120 of the particular type of portable device 118.

The portable device 118 provides a monaural or stereo audio signal to the audio system 100 via an audio output receptacle 122, into which the audio lead 112 can be inserted. The characteristics of the audio output receptacle 122, such as the arrangement of conductors within the audio output receptacle 122 and the shape of the audio output receptacle 122, are typically consistent with industry-accepted conventions. Accordingly, the audio lead 112 is preferably implemented in a configuration that is also consistent with conventions accepted in the industry.

With the body 108 of the power/audio cord 104 carrying both power and audio signals, a single cord can both provide power from the audio system 100 to the portable device 118 and provide a monaural or stereo audio signal from the portable device 118 to the audio system 100. The audio signal thus provided can then be audibly reproduced by the audio system 100. It will be appreciated by those skilled in the art that the power lead 110 and the audio lead 112 need not both be used. For example, the portable device 118 may be a device that lacks an audio output receptacle 122, such as a radar detector or a handheld computer. In such cases, the audio terminal 116 may be left disconnected. Similarly, if the portable device 118 does not have a power receptacle 120, the power terminal 114 may be left disconnected, and the power/audio cord 104 may be used to conduct audio signals only.

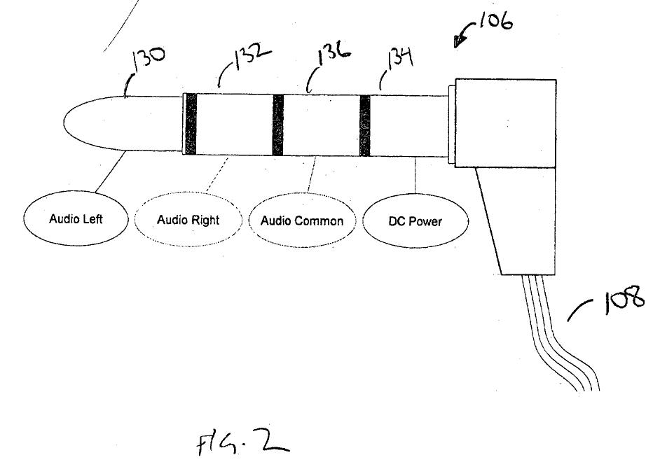

FIG. 2 illustrates an example implementation of the power/audio terminal 106 for conducting a power signal and a stereo audio signal. The power/audio terminal 106 is divided into four segments. An audio left channel segment 130 and an audio right channel segment 132 respectively conduct the left and right channel signals of a stereo audio signal output by the portable device 118. A DC power segment 134 is housed with but electrically isolated from the audio left channel segment 130 and the audio right channel segment 132 and delivers a DC power signal to the portable device 118. The DC power signal supplies the portable device 118 with a DC voltage of, for example, 5 VDC. Accordingly, with a DC voltage supplied via the power/audio terminal 106, the portable device 118 does not require battery power. A return segment 136 provides a return path for the DC voltage and for the left and right channel audio signals. The return segment 136 is housed with but electrically isolated from the audio left channel segment 130, the audio right channel segment 132, and the DC power segment 134.

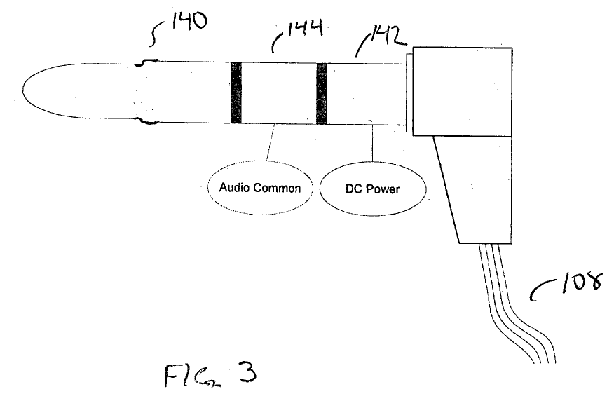

FIG. 3 illustrates an implementation of the power/audio terminal 106 for conducting a power signal and a monaural audio signal. The power/audio terminal 106 is divided into three segments. An audio segment 140 conducts a monaural audio signal output by the portable device 118. A DC power segment 142 is housed with but electrically isolated from the audio segment 140 and delivers a DC power signal to the portable device 118. The DC power signal supplies the portable device 118 with a DC voltage of, for example, 5 VDC. Accordingly, with a DC voltage supplied via the power/audio terminal 106, the portable device 118 does not require battery power. A return segment 144 provides a return path for the DC voltage and for the audio signal. The return segment 144 is housed with but electrically isolated from the audio segment 140 and the DC power segment 142.

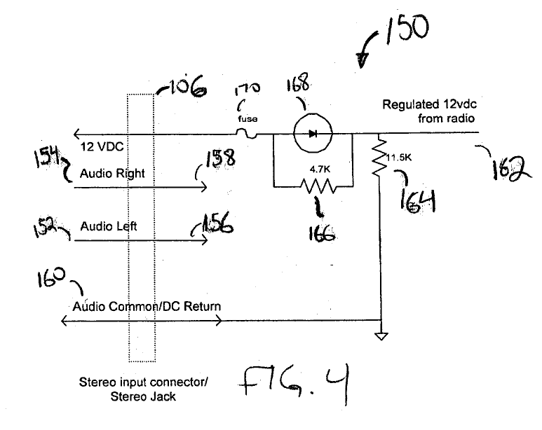

FIG. 4 is a schematic diagram illustrating a circuit arrangement 150 for conducting a power signal and an audio signal. More particularly, the circuit arrangement 150 and the power/audio terminal 106 may conduct a power signal from the audio system 100 to the portable device 118 and an audio signal from the portable device 118 to the audio system 100. The left and right channel signals of the stereo audio signal are received at inputs 152 and 154, respectively, and are provided to the audio system 100 at outputs 156 and 158. A common conductor 160 provides an audio common path. While the circuit arrangement 150 is depicted in FIG. 4 as conducting a stereo audio signal, those skilled in the art will appreciate that the circuit arrangement 150 can alternatively conduct a monaural audio signal. In a monaural implementation, the circuit arrangement 150 receives the audio signal from the portable device 118 at a single input and provides the audio signal to the audio system 100 at a single output.

The audio system 100 supplies a power signal to the circuit arrangement 150 at a power input 162. The power signal may be obtained, for example, by regulating the voltage from the vehicle battery to 12 VDC. Alternatively, the power signal may be a filtered power signal provided by a high fidelity driver. The common conductor 160 provides a return path for the power signal.

The circuit arrangement 150 protects the portable device 118 from an overload in either voltage or current in the power signal. For example, a resistor 164 provides protection against a voltage overload in the event of a short by absorbing some of the voltage, thereby preventing the portable device 118 from receiving the entire voltage. A resistor 166 provides additional protection from a voltage overload in the event of a short to ground. Further, a diode 168 protects the portable device 118 from voltage overloads attributable to sources external to the audio system 100. An optional fuse 170 provides protection against a current overload. As an alternative, a current detector (not shown) may provide current overload protection. When the current sensed by the current detector exceeds a threshold, the circuit arrangement 150 may be turned off. The circuit arrangement 150 can be restarted on a subsequent ignition cycle. Using a current detector rather than the fuse 170 offers the advantage of avoiding the need to replace the fuse 170 after each current overload incident.

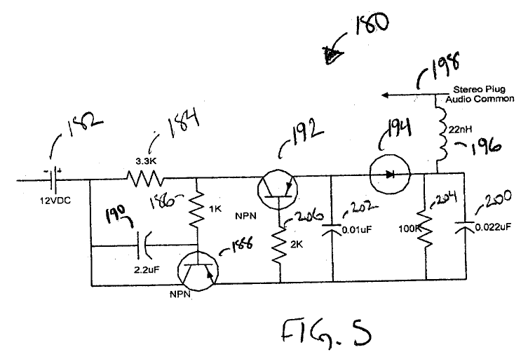

FIG. 5 is a schematic diagram illustrating another example circuit arrangement 180 for conducting a power signal from the audio system 100 to the portable device 118 and an audio signal from the portable device 118 to the audio system 100. Because the components depicted in FIG. 5 are involved in conducting the power signal only, the audio inputs and outputs are omitted for illustration purposes. Those skilled in the art will appreciate that the circuit arrangement 180 can conduct either a monaural or a stereo audio signal.

A power supply 182 provides a power signal to the portable device 118 via the circuit arrangement 180. The power supply 182 may be implemented, for example, by regulating the voltage from the vehicle battery to 12 VDC. Alternatively, the power supply 182 may be implemented as a high fidelity driver that delivers a filtered power signal. In either case, the circuit arrangement 180 protects the portable device 118 from excessive current or voltage by limiting the current and voltage delivered to the portable device 118. For example, resistors 184 and 186 form a voltage divider. A transistor 188, depicted as an NPN transistor, acts as a current sink. A capacitor 190 filters out AC components of the signal present at the base of the transistor 188. A transistor 192, depicted as an NPN transistor, provides additional protection by turning the circuit arrangement 180 off in response to a voltage overload. Further, a diode 194 protects the portable device 118 from voltage overloads attributable to sources external to the audio system 100. An inductor 196 acts as a choke to filter the power signal delivered to the portable device 118 as a DC offset at an output 198. Additional filtering is performed by capacitors 200 and 202 and resistors 204 and 206.

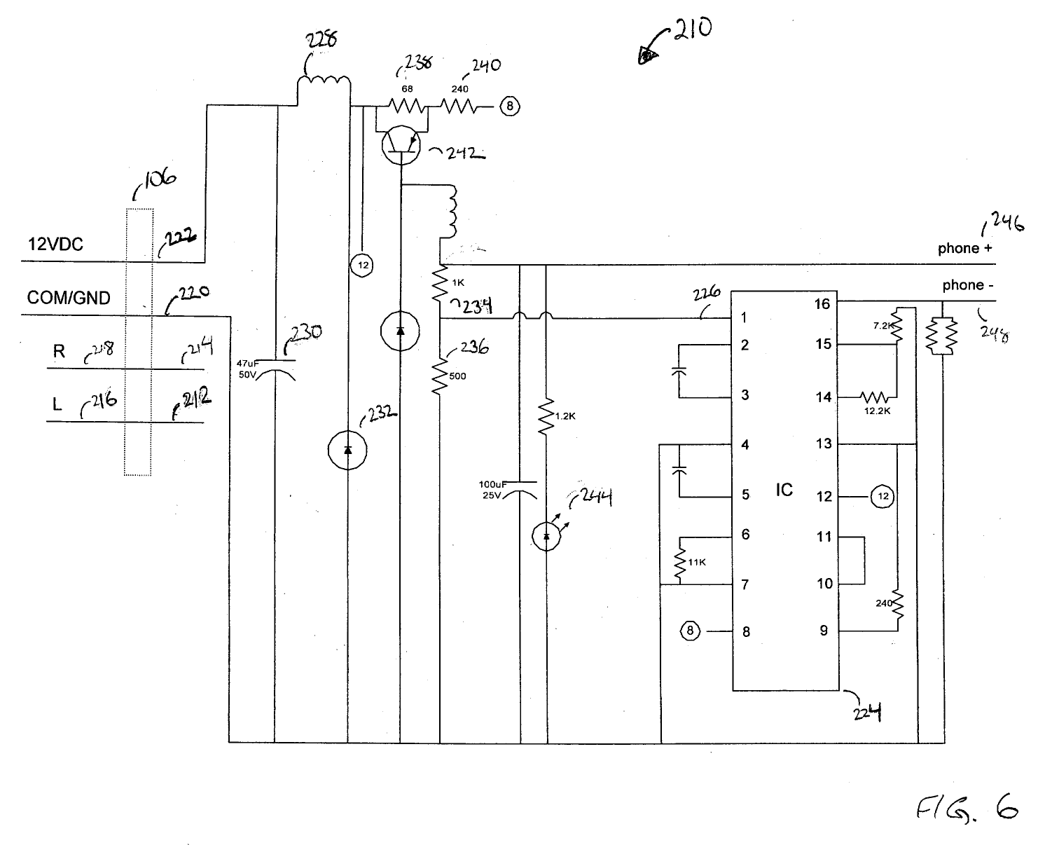

FIG. 6 is a schematic diagram illustrating yet another example circuit arrangement 210 for conducting a power signal and an audio signal. More particularly, the circuit arrangement 210 and the power/audio terminal 106 may conduct a power signal from the audio system 100 to the portable device 118 and an audio signal from the portable device 118 to the audio system 100. The left and right channel signals of the stereo audio signal are received at inputs 212 and 214, respectively, and are provided to the audio system 100 at outputs 216 and 218. A common conductor 220 provides an audio common path. While the circuit arrangement 210 is depicted in FIG. 6 as conducting a stereo audio signal, those skilled in the art will appreciate that the circuit arrangement 210 can alternatively conduct a monaural audio signal. In a monaural implementation, the circuit arrangement 210 receives the audio signal from the portable device 118 at a single input and provides the audio signal to the audio system 100 at a single output.

The audio system 100 supplies a power signal to the circuit arrangement 210 at a power input 222. The power signal may be obtained, for example, by regulating the voltage from the vehicle battery to 12 VDC. Alternatively, the power signal may be a filtered power signal provided by a high fidelity driver. The common conductor 220 provides a return path for the power signal.

The circuit arrangement 210 can be used to charge a battery in the portable device 118, e.g., a wireless telephone. In charging applications, proper regulation of the voltage output is important. Accordingly, a voltage regulator integrated circuit (IC) 224 monitors the current drawn by the portable device 118 and turns the circuit arrangement 210 off when the portable device 118 is fully charged, stopping voltage delivery to the portable device 118. In this way, the circuit arrangement 210 protects the portable device 118 from overcharging.

The IC 224 receives a DC voltage at an input 226. An inductor 228 and a capacitor 230 filter out noise from the power signal at the power input 222. A diode 232 protects the portable device 118 from voltage overloads attributable to sources external to the audio system 100. Resistors 234 and 236 form a voltage divider that sets the voltage presented at the input 226. A feedback arrangement formed by resistors 238 and 240 and a transistor 242 and coupled to the IC 224 stops voltage delivery to the portable device 118 when the portable device 118 is fully charged. A light emitting diode (LED) 244 illuminates when the circuit arrangement 210 is charging the portable device 118. The circuit arrangement 210 delivers a charging voltage to the portable device 118 at outputs 246 and 248.

As demonstrated by the foregoing discussion, various embodiments of the present invention may facilitate the use of portable audio devices with vehicle audio systems and other types of audio systems. By conducting audio and power signals with a single cord, the present invention avoids the need for multiple cords. Further, a vehicle audio system can deliver power to a portable device without the use of relatively large auxiliary power jacks, sometimes known as cigarette lighter adapters. Accordingly, additional space may be made available on various surfaces of the vehicle for other applications, such as instrumentation or other features.

It will be understood by those who practice the invention and those skilled in the art that various modifications and improvements may be made to the invention without departing from the spirit and scope of the disclosed embodiments. The scope of protection afforded is to be determined solely by the claims and by the breadth of interpretation allowed by law.

What is claimed is:

1. An electrical interface comprising:
a cord comprising a plurality of conductors, a portion of the cord divided into a first branch comprising a first subset of the conductors and a second branch comprising a second subset of the conductors;
an audio connector coupled to the first branch and arranged to conduct an audio signal;
a power connector coupled to the second branch and arranged to conduct a power signal; and
a third connector coupled to the cord and arranged to conduct the audio signal and the power signal.

2. The electrical interface of claim 1, wherein the third connector comprises:
at least one audio segment to conduct the audio signal;
a power segment to conduct the power signal; and
a common segment configured to provide a return path for the audio signal.

3. The electrical interface of claim 1, wherein the audio connector is arranged to conduct one of a stereo audio signal and a monaural audio signal.

4. An electrical connector comprising:
at least one audio segment arranged to conduct an audio signal;
a power segment housed with and electrically isolated from the at least one audio segment and arranged to conduct a power signal; and
a common segment housed with and electrically isolated from the at least one audio segment and the power segment and arranged to provide a return path for the audio signal.

5. The electrical connector of claim 4, wherein the at least one audio segment is arranged to conduct one of a stereo audio signal and a monaural audio signal.

6. The electrical connector of claim 4, wherein the at least one audio segment comprises an audio left channel segment and an audio right channel segment.

7. The electrical connector of claim 4, wherein the electrical connector comprises one of a terminal and a receptacle.

8. An audio system comprising:
an electrical receptacle comprising
a power segment coupled to a power supply;
at least one audio segment coupled to an audio input of the audio system and arranged to conduct an audio signal from an external audio device to the audio system, the at least one audio segment electrically isolated from the power segment; and
a common segment electrically isolated from the at least one audio segment and the power segment and arranged to provide a return path for the audio signal.

9. The audio system of claim 8, wherein the power supply comprises at least one of a vehicle battery and a high fidelity driver.

10. The audio system of claim 8, further comprising an overload protection arrangement.

11. The audio system of claim 10, wherein the overload protection arrangement comprises at least one of a diode, a fuse, and a current detector.

12. The audio system of claim 8, further comprising a voltage regulator arrangement.

13. The audio system of claim 12, wherein the voltage regulator arrangement comprises an integrated circuit (IC).
